(19) United States
(12) Patent Application Publication
(10) Pub. No.: US 2009/0258333 A1
(43) Pub. Date: Oct. 15, 2009

(54) SPOKEN LANGUAGE LEARNING SYSTEMS

(76) Inventor: KAI YU, Cambridge (GB)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 12/405,434

(22) Filed: Mar. 17, 2009

(30) Foreign Application Priority Data
Mar. 17, 2008 (GB) 0804930.6

(51) Int. Cl. G09B 19/06; G09B 5/00

(52) U.S. Cl. 434/157; 434/169

(57) ABSTRACT

This invention relates to systems, methods and computer program code for facilitating learning of spoken languages. We describe a computing system to facilitate learning of a spoken language, the system comprising: a user interface to prompt a user of the system to produce a spoken language goal and to capture audio data comprising speech captured from said user in response; a speech analysis system to analyse said captured audio data to determine acoustic or linguistic pattern features of said captured audio data; a pattern matching system to match one or more subsets of said pattern features to a database of pattern features and to determine feedback data responsive to said match; and a feedback system to provide feedback to said user using said feedback data to facilitate said user to achieve said spoken language goal.

### FIELD OF THE INVENTION

This invention relates to systems, methods and computer program code for facilitating learning of spoken languages.

### BACKGROUND TO THE INVENTION

Spoken language learning is the most difficult task for foreign language learners due to the lack of practice environment and personalised instructions. Though machines have been used for assisting general language learning, the use of machines for spoken language learning has not yet been effective and satisfactory. Some techniques related to speech recognition and pronunciation scoring have been applied for spoken language learning. However, the current techniques are very limited.

Background prior art can be found in WO 2006/031536; WO 2006/057896; WO 02/50803; U.S. Pat. No. 6,963,841; US 2005/144010; WO 99/40556; WO 02/50799; WO 98/02862; US 2002/0086269; WO 2004/049283; WO 2006/057896; US 2002/0086268; and WO 2007/015869.

There is a need for improved techniques.

### SUMMARY OF THE INVENTION

According to the invention there is therefore provided a computing system to facilitate learning of a spoken language, the system comprising: a user interface to prompt a user of the system to produce a spoken language goal and to capture audio data comprising speech captured from said user in response; a speech analysis system to analyse said captured audio data to determine acoustic or linguistic pattern features of said captured audio data; a pattern matching system to match one or more subsets of said pattern features to a database of pattern features and to determine feedback data responsive to said match; and a feedback system to provide feedback to said user using said feedback data to facilitate said user to achieve said spoken language.

In some preferred implementations of the system the database of pattern features is configured to store sets of linked data items. A set of linked data items in embodiments comprises a feature data item, such as a feature vector, comprising a group of the pattern features for identifying an expected spoken response from the user to the spoken language goal. A set of linked data items also includes an instruction data item comprising instruction data for instructing the user to improve or correct an error in the captured speech (or for rewarding the user for a correct response). The instructions may be provided in any convenient form including, for example, spoken instructions (using a speech synthesiser) and/or written instructions in the form of text output, and/or graphical instructions, for example in the form of icons.

The set of linked data items also includes a goal data item identifying a spoken language goal; in this way the spoken language goal identifies a set of linked data items comprising a set of expected responses to the spoken language goal, and a corresponding set of instruction data items for instructing the user based on their response. The spoken language goal may take many forms including, but not limited to, goals designed to test pronunciation, fluency, intonation (for example pitch trajectory), tone (for example for a tonal language), stress, word choice and the like. For example for a tonal language the goal might be to produce a particular tone and the captured audio from the user, more particularly the pattern features from the captured audio, may be employed to match the captured tone to one of a set of, say, five tones. Thus in embodiments the pattern matching system is configured to match the pattern features of the captured audio data to pattern features of a feature data item (or feature vector) in a set corresponding to the spoken language goal, whence the instructions may be derived from an instruction data item linked to the matched feature data item. In this way the instructions to the user correspond to an identified response from a set of expected responses to the spoken language goal, for example a set of predefined errors or alternatives and/or optionally including a correct response. The skilled person will appreciate that a set of expected responses may comprise one or more responses and that a corresponding set of instruction data items may comprise one or more instruction data items. In preferred embodiments a set of expected responses (and instruction data items) comprises two or more expected responses, but this is not essential.

In embodiments the subsets of the pattern features which are matched with the database relate to acoustic or linguistic elements of the captured spoken speech, for example a group of pattern features relating to word or phone pitch trajectory and/or energy, or a group of pattern features relating to a larger linguistic element such as a sentence, which could include, say, pattern features relating to word sequence and semantic items within the sentence. Conveniently a group of pattern features may be considered as a vector of elements, in which each element may comprise a data type such as a vector (for example for a pitch trajectory in time), an ordered list (for example for a word sequence) and the like. In general the set of acoustic and/or linguistic pattern features may be selected from the examples described later.

In some preferred embodiments the acoustic pattern analysis system is configured to identify one or more of phones, words and sentences from the spoken language and to provide associated confidence data such as a posteriori probability data, and the acoustic pattern features may then comprise one or more of phones, words and sentences and associated confidence scores. In preferred embodiments the acoustic pattern analysis system is further configured to identify prosodic features in the captured audio data, such a prosodic feature comprising a combination of a determined fundamental frequency of a segment of the captured audio corresponding to a phone or word, a duration of the segment of captured audio and an energy in the segment of captured audio; the acoustic pattern features then preferably include such prosodic features.

In some preferred embodiments the feedback data comprises an index to an instruction record in the database, the index being determined by the degree of match or best match of a group of pattern features identified in the captured speech to a group of pattern features in the database. Knowing the goal presented by the system to the user, the best match of a group of features for a phone, word, grammatical feature or the like may be used to determine whether the user was correct (or to what degree correct) in their response. The instruction record may comprise instruction data such as text, multimedia data and the like, for outputting to the user to improve or correct the user's speech. Thus the instruction data may comprise instructions to correct an error and/or instructions offering an alternative to the user-selected expression which might be considered more natural in the language.

In embodiments of the system the instructions are hierarchically arranged, in particular including at least an acoustic level and a linguistic level of instruction. In this way the system may select a level of instruction based upon a selected or determined level or skill of the user in the spoken language and/or a difficulty of the spoken language goal. For example a beginner may be instructed at the acoustic level whereas a more advanced speaker may be instructed at the linguistic or semantic level. Alternatively a user may select the level at which they wish to receive instruction.

In some preferred implementations of the system the feedback to the user may include a score. One problem with such a computer-generated score is that this is essentially arbitrary. However, interestingly, it has been observed that if human experts, for example teachers, are asked to grade an aspect of a speaker's speech as say good or bad or on a 1 to 10 scale there is a relatively high degree of consistency between the results. Recognising this preferred embodiments of the system preferably include a mapping function to map from a score determined by a goodness of match of a captured group of pattern features to the database to a score which is output from the system. In embodiments this mapping function is determined by using a set of training data (captured speech) for which scores from human experts are known. The purpose of the mapping function is to map the scores generated by the computer system so that given the same range over which scores are allowed the computing system generates scores which correlate with the human scores, for example with a correlation coefficient of greater than 0.5, 0.6, 0.7, 0.8, 0.9, or 0.95.

In preferred embodiments of the system the speech analysis system comprises an acoustic pattern analysis system and a linguistic pattern analysis system. Preferably each of these is provided by a speech recognition system including both an acoustic model and a linguistic model; in embodiments they are provided by a speech analysis system, which makes use of the results of a speech recognition system. The acoustic model may be employed to determine the likelihood that a segment of the captured audio, more particularly a feature vector derived from this segment, corresponds to a particular word or phone. The linguistic or language model may be employed to determine the a priori probability of a word given previously identified words/phones or, more particularly, a set of strings of previously determined phones/words with corresponding individual and overall likelihoods (rather in the manner of trellis decoding). In preferred embodiments the speech recognition system also cuts the captured data at detected phone and/or word boundaries and groups the pattern features provided from the acoustic and linguistic models according to these detected boundaries.

In some preferred embodiments the acoustic pattern analysis system identifies one or more of phones, words and sentences from the spoken language together with associated confidence level information, and this is used to construct an acoustic pattern feature vector. In embodiments the acoustic analysis system makes use of the phone/word, confidence score and time boundary information from the speech recognition system and constructs an acoustic pattern which is different from the speech recognition features. These acoustic pattern features, such as pitch trajectory for each phone or average phone energy corresponds to learning-specific aspects of the captured audio. The linguistic pattern analysis system in some preferred embodiments is used to identify a grammatical structure of the captured speech. This is done by storing in the system a plurality of different types of grammatical structure and then matching a grammatical structure identified by the linguistic pattern analysis system to one or more of these stored types of structure. In a simple example the sentence “please take the bottle to the kitchen” may be identified by the linguistic pattern analysis system as having the structure “Take X to Y.” and once this has been identified a look-up may be performed to determine whether this structure is present in a grammar index within the system. In preferred embodiments one of the linguistic pattern features used to match and index the instructions in the database comprises data identifying whether a captive segment of speech has a grammar which fits with a pattern in the grammar index.

In embodiments of the system the linguistic pattern analysis may additionally perform semantic decoding, by mapping the captured and recognised speech onto a set of more general semantic representations. For example the sentence “Would you please tell me where to find a restaurant?” may be semantically characterised as “request”+“location”+“eating establishment”. The skilled person will understand that examples of speech recognition systems which perform analysis of this type at the semantic level are known in the literature (for example S. Seneff. Robust parsing for spoken language systems. In Proc. ICASSP, 2000); here the semantic structure of the captured audio may form one of the elements of a pattern feature vector used to index the database of instructions.

In embodiments of the system one or both of the acoustic and linguistic pattern analysis systems may be configured to match to erroneous acoustic or linguistic/grammatical structures as well as correct structures. In this way common errors may be detected and corrected/improved. For example a native Japanese speaker may commonly substitute an “L” phone for an “R” phone (since Japanese lacks the “R” sound) and this may be detected and corrected. In a similar way, the use of a formal response such as “How do you do?” may be detected in response to a prompt to produce an informal spoken language goal and then an alternative grammatical structure more appropriate to an informal question may be suggested as an improvement.

In preferred embodiments of the system the linguistic pattern analysis system is also configured to identify in the captured speech one or more key words of a set of key words, in particular “grammatical” key words such as conjunctions, prepositions and the like. The acoustic pattern analysis system may then be employed to determine confidence data for these identified key words. In embodiments the confidence score of these key words is employed as one of the pattern features used to index a database, which is useful as these words can be particularly important in speaking a language so that it can be readily comprehended.

In some particularly preferred embodiments one or more spoken languages for which the system provides machine-aided learning comprises a tonal language such as Chinese. Preferably the feedback data then comprises pitch trajectory data. In some preferred embodiments the feedback to the user comprises a graphical representation of the user's pitch trajectory for a phone, word or sentence of the tonal language together with a graphical indication of a desired pitch trajectory for the phone/word/sentence. (In this specification phone refers to a smallest acoustic unit of expression such as a tone in a tonal language or a phoneme in, say, English).

In some particularly preferred embodiments of the system, the computing system is adaptive and able to learn from its users. Thus in embodiments the system includes a historical data store to store acoustic and/or linguistic pattern feature vectors determined from captured speech of a plurality of users. Within a subset of pattern features a consistent set of features may be identified which does not closely match with a stored pattern in the database. In such a case a new entry may be made in the database corresponding, in effect, to a common, new type of error. Thus embodiments of the language learning system may include a code module to identify new pattern features within the historical data not within the database of pattern features and, responsive to this, to add these new pattern features to the database. In some cases this may be done by re-partitioning existing sets of pattern features within the database, for example to repartition a pitch trajectory spanning, say, 40 Hz to 100 Hz into two separate pitch trajectories say 40-70 Hz and 70-100 Hz. In some implementations an interface may be provided for an expert to validate the putative identified new pattern features. Then the expert may add new instructions into the instruction data in the database corresponding to the new pattern features identified. Additionally or alternatively however provision may be made to question a user on how an error associated with the identified new set of pattern features was corrected, and then this information, for example in the form of a text note, may be included in the database. Preferably in this latter case prior to incorporation of the information in the database the “correction” data is presented to a plurality of other users with the same detected error to determine whether a majority of them concur that the instruction data does in fact help to correct the error.

The above-described computing system may additionally or alternatively be employed to facilitate testing of a spoken language, and in this case the feedback system may additionally or alternatively be configured to produce a test result in addition to or instead of providing feedback to the user.

The skilled person will understand that the language learning computing system may be implemented in a distributed fashion over a network, for example as a client server system. In other embodiments the computing system may be implemented upon any suitable computing device including, but not limited to, a laptop, a mobile computing device such as a PDA and so forth.

The invention further provides computer program code to implement embodiments of the system. The code may be provided on a carrier such as a disk, for example a CD- or DVD-ROM, or in programmed memory for example as Firmware. Code (and/or data) to implement embodiments of the invention may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog (Trade Mark) or VHDL (Very high speed integrated circuit Hardware Description Language). As the skilled person will appreciate such code and/or data may be distributed between a plurality of coupled components in communication with one another.

The invention further provides a speech processing system for processing speech and outputting instruction data items responsive to identified acoustic and linguistic patterns in said speech, the system comprising a front end processing module, a statistical speech recognition module, an acoustic pattern feature extraction module, a linguistic pattern feature extraction module, a pattern feature memory, and a pattern matching module.

The front end processing module comprises an input to receive analogue speech data, an analogue to digital converter to convert the analogue speech data into digital speech data, means for performing a Fourier analysis on the digital speech data to provide a frequency spectrum of the digital speech data, means for generating feature vector data and prosodic feature data from the frequency spectrum of the digital speech data. The prosodic feature data comprises a combination of a determined fundamental frequency of a segment of the digital speech data corresponding to a phone or a word, a duration of the digital speech data and an energy in the segment of digital speech data.

The statistical speech recognition module is coupled to the front end processing module, and comprises an input to receive the feature vector data and the prosodic feature data, and a lexicon, an acoustic model, and a language model.

The lexicon comprises an input to receive the prosodic feature data, a memory storing a pre-determined mapping of the prosodic feature data to acoustic data items, and an output to output the acoustic data items. The acoustic data items comprise of one or more of data defining phones and data defining words and data defining syllables.

The acoustic model comprises an input to receive the acoustic data items, the feature vector data and the prosodic feature data. The acoustic model further comprises a probabilistic model operable to determine the probability of the acoustic data items existing in the feature vector data and the prosodic feature data, selecting the acoustic data items with a highest match probability and outputting the acoustic data items with said highest match probability.

The language model comprises an input to receive the acoustic data items from the lexicon and an output to output a language data item. The language data item comprises data identifying one or more of phones, words and syllables in the digital speech data. The language model further comprises means to analyse at least one previously generated language data item and the acoustic data items from the lexicon and to generate a further language data item for output.

The acoustic pattern feature extraction module is coupled to the statistical speech recognition module and the front end processing module, comprising an input to receive the acoustic data items from the statistical speech recognition module, and an input to receive the prosodic feature data from the front end processing module. The acoustic pattern feature extraction module further comprises means for determining acoustic features of the acoustic data items from the prosodic data items, the acoustic features comprising pitch trajectory, and outputting acoustic feature data items defining the acoustic features.

A linguistic pattern feature extraction module is coupled to the statistical speech recognition module and comprises an input to receive the language data items and a memory storing predefined linguistic structures. The linguistic structures store at least one of grammatical patterns and semantic patterns. The linguistic pattern feature extraction module further comprises means for matching the language data items to the predefined linguistic structures, and means for outputting a linguistic structure data item comprising data characterising a linguistic structure of the language data items according to the predefined linguistic structures in the linguistic structure memory.

A pattern feature memory is configured to store a plurality of pattern-instruction pairs, the pattern item in the pattern-instruction pair defining a language learning goal and an instruction in the pattern-instruction pair defining an instruction item responsive to the pattern item defining a language learning goal.

A pattern matching module is coupled to the acoustic pattern feature extraction module and the linguistic pattern feature extraction module and the pattern feature memory. The pattern matching module comprises an input to receive the acoustic feature data items from the acoustic pattern feature extraction module, and an input to receive the linguistic structure data items from the linguistic pattern feature extraction module. The pattern matching module further comprises means for matching the acoustic feature data items to the plurality of pattern-instruction pairs in the pattern feature memory by comparing the pattern items in the pattern-instruction pair and the acoustic feature data items output from the acoustic pattern feature extraction module. The pattern matching module further comprises means for matching the linguistic structure data items to the plurality of pattern-instruction pairs by comparing the linguistic structure data items with the pattern items in the plurality of acoustic and linguistic pattern-instruction pairs, outputting the instruction items responsive to the pattern items in the plurality of acoustic and linguistic pattern-instruction pairs.

In some preferred implementations of the speech processing system the pattern item in the pattern-instruction pair may define an erroneous language learning goal. An instruction in the pattern-instruction pair may define an instruction item responsive to the pattern item, the instruction item comprising data for instructing correction of at least one of the acoustic feature data items and the linguistic structure data items matching the pattern item defining an erroneous language learning goal.

In some preferred embodiments of the speech processing system the feature vector data generated in the front end processing module may be perceptual linear prediction (PLP) feature data.

In some preferred embodiments of the speech processing system the acoustic features determined in the acoustic pattern feature extraction module may further comprise at least one of duration and energy and confidence score of the acoustic data items.

In some preferred embodiments of the speech processing system the probabilistic model in the acoustic model may be a Hidden Markov Model.

In some preferred embodiments of the speech processing system the speech processing system may further comprise an adaptation module. The adaptation module may comprise an historical memory configured to store historical data items from a plurality of different users. The historical memory may comprise one or both of the acoustic feature data items and the linguistic structure data items. The adaptation module may have means to identify within the historical data items new pattern items not within the pattern feature memory and may add the new pattern items to the pattern-instruction pairs in the pattern feature memory responsive to the identification.

In some preferred embodiments of the speech processing system the adaptation module may be further operable to add new instruction items to the pattern-instruction pairs in the pattern feature memory. The new instruction items may comprise data captured from new digital speech data generated from the users. The new digital speech data generated may define a response associated with the new pattern items added to the pattern feature memory.

### BRIEF DESCRIPTION OF THE DRAWINGS

These and other aspects of the system will now be further described, by way of example only, with reference to the accompanying figures in which:

FIG. 1 shows a block diagram of an embodiment of the system;

FIG. 2 shows a left-to-right HMM with three emitting states;

FIG. 3 shows time boundary information of a recognised sentence;

FIG. 4 shows an example of comparative pitch trajectories for instructing a user to learn a tonal language; and

FIG. 5 shows an overview block diagram of the system.

### DETAILED DESCRIPTION OF PREFERRED EMBODIMENTS

We describe a machine-aided language learning method and system using predefined structured database of possible language learning errors and corresponding teaching instructions. The learning errors include acoustic and linguistic errors. Learning errors are represented as serial feature vectors, where the feature can be word sequences, numbers or symbols. The “machine” can be a computer or another electrical device. The method and system can be used for different languages such as Chinese and English. The method and system can be applied for both teaching and testing, depending on the content provided.

Broadly we describe a method and system of adaptive machine-aided spoken language learning capable of automatic speech recognition, learning-specific feature extraction, heuristic error (alternative analysis) and learning instruction. The user speaks to an electrical device. The audio is then analyzed using speech recognition and learning-specific feature extraction technology, where acoustic and linguistic error features are formed. The features are used to search from a structured database of possible errors and corresponding teaching instructions. Personalised feedbacks comprising error analysis and instructions are then provided by an intelligent generator given the search results. The system can also be adapted by the analysing the user's learning experience, though which new knowledge or personalised instructions may be generated. The system can operate in either an interactive dialogue mode for short sentences or a summary mode for long sentences or paragraphs.

Embodiments of the system we describe provide non-heuristic determined feedback with validated artificial scores. The methods or systems can give feedback according to the correct knowledge and can identify rich and specific learning error types of the learner and intelligently offer extended personalized instructions on correcting the errors or further improving skills. They have well-defined, rich and compact feature representations of learning-specific acoustic and linguistic patterns. Therefore, they can visualize the learner's performance against standard one in a normalised thus sensible way. Consequently, statistical models and methods may be used to analyse the learner's input. The pronunciation scores given are artificial measures calculated by computer. although validation against human beings has been applied, hence they are trustable. Further they facilitate the creation of new knowledge, and are therefore evolutive.

In more detail we describe a method and system using speech analysis technologies to generate and summarize learning specific pattern features and using structured knowledge base of learning patterns (especially error patterns) and corresponding teaching instructions to provide intelligent and rich feedback.

Possible acoustic and linguistic patterns (learning errors and all kinds of alternative oral sentences) of foreign language learners are collected from real learning cases. They are then analyzed using machine learning approaches to form a serial of compact feature vectors reflecting various learning aspects. The feature vectors can be combined to calculate a specific or general quantitative score of various learning aspect, such as pronunciation, fluency, or grammar correctness. These quantitative scores are ensured to be highly correlated to the scores that human teacher may give by using statistical regression. Furthermore, in the database, the pattern features are grouped and each pattern feature group has a distinct and specific instruction. Hence, the possible instructions can be regarded as a function of the learning-specific speech pattern feature vectors. When a language learner speaks to the machine, input audio is processed to yield the acoustic and linguistic pattern features. A search is then performed to find similar learning-specific speech pattern feature records in the database. Corresponding teaching instructions are then extracted and assembled to yield a complete instruction output of text or multimedia. Speech synthesis or human voices are used to produce speech output of the instructions. The instructions as well as the quantitative evaluation scores are then output to guide the user. When the search fails to find the appropriate pattern feature in the database, the information is fed back to the centralized database. Each time similar features are identified, it would be counted, analyzed and added as new knowledge to the database when appropriate. Should there be any progress of any user managing to overcome certain pattern features of learning errors, he or she may be asked to enter any know-how, which may then be classified as new experience knowledge added to the database.

Embodiments of the invention can give validated feedback to the language learner on general acoustic and linguistic aspects. The abundance and accuracy gives the learner a better idea of the overall performance. Furthermore, embodiments of the invention provide rich personalized instructions based on the user's input and the speech pattern/instruction database. This includes error correction and/or alternative rephrase instructions specifically tailored for the user. Also, the invention would allow to capture any new knowledge (new speech pattern/instruction) and evolve over time. Hence, it is more intelligent and useful than the current non-heuristic systems.

An example English learning system using the proposed methods is described in detail as below. In this example, the target language learners are native Chinese speakers. The target domain is a tourist information domain and the running mode is sentence level interaction. The whole system is running on a PC with internet access. Microphone and headphone are used as input and output interfaces.

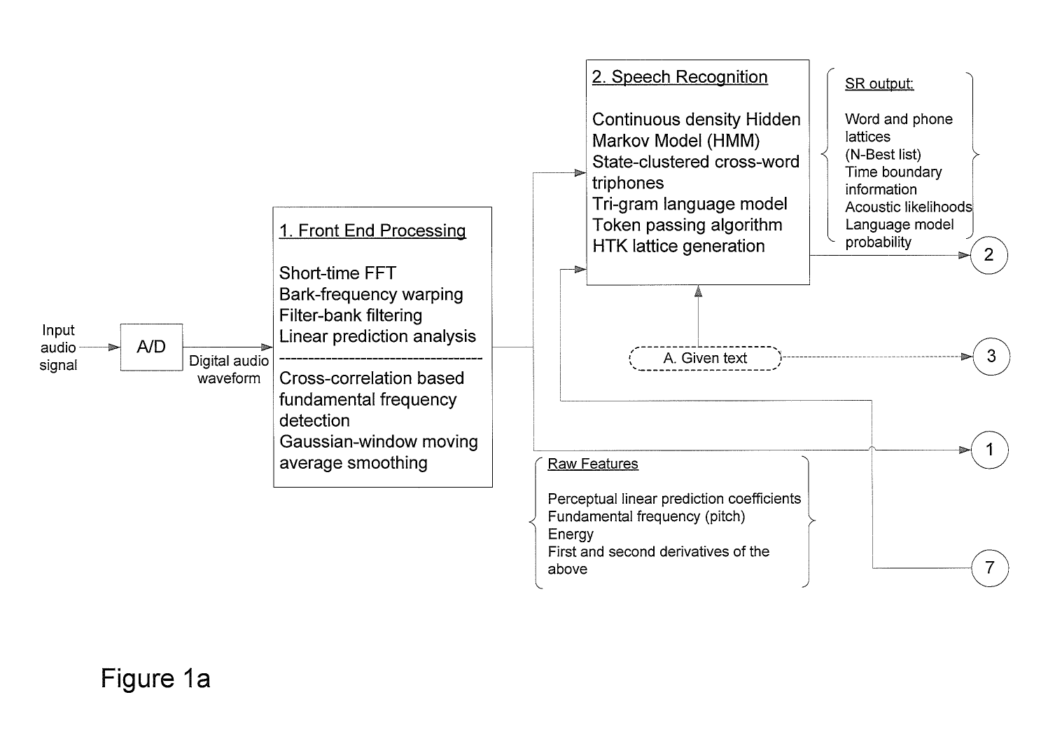

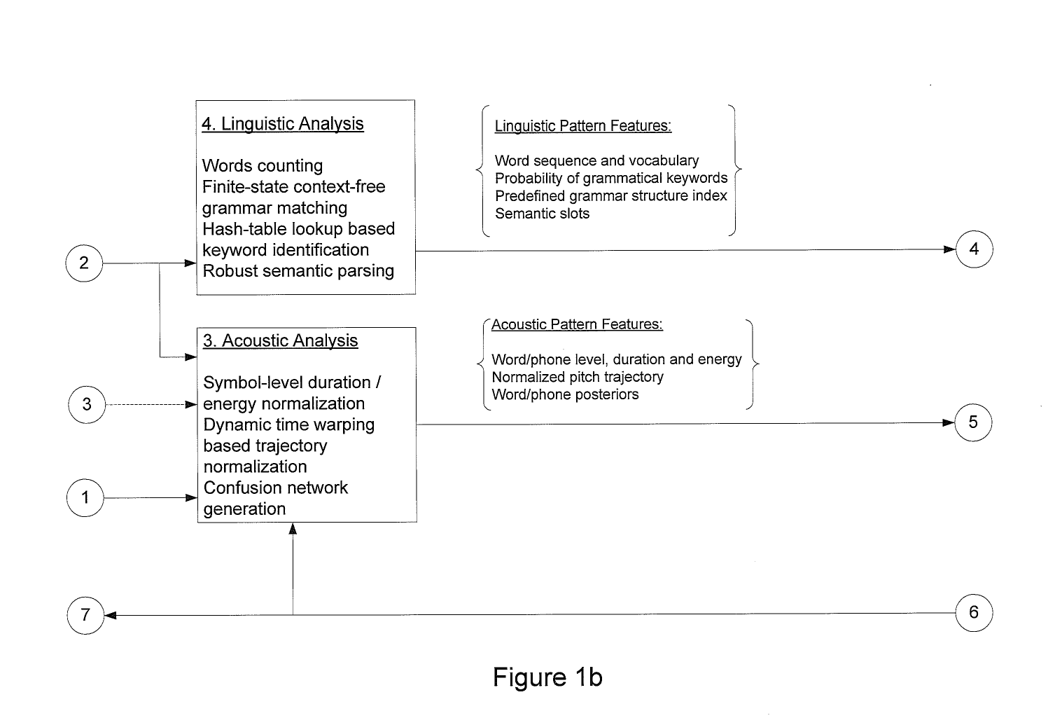

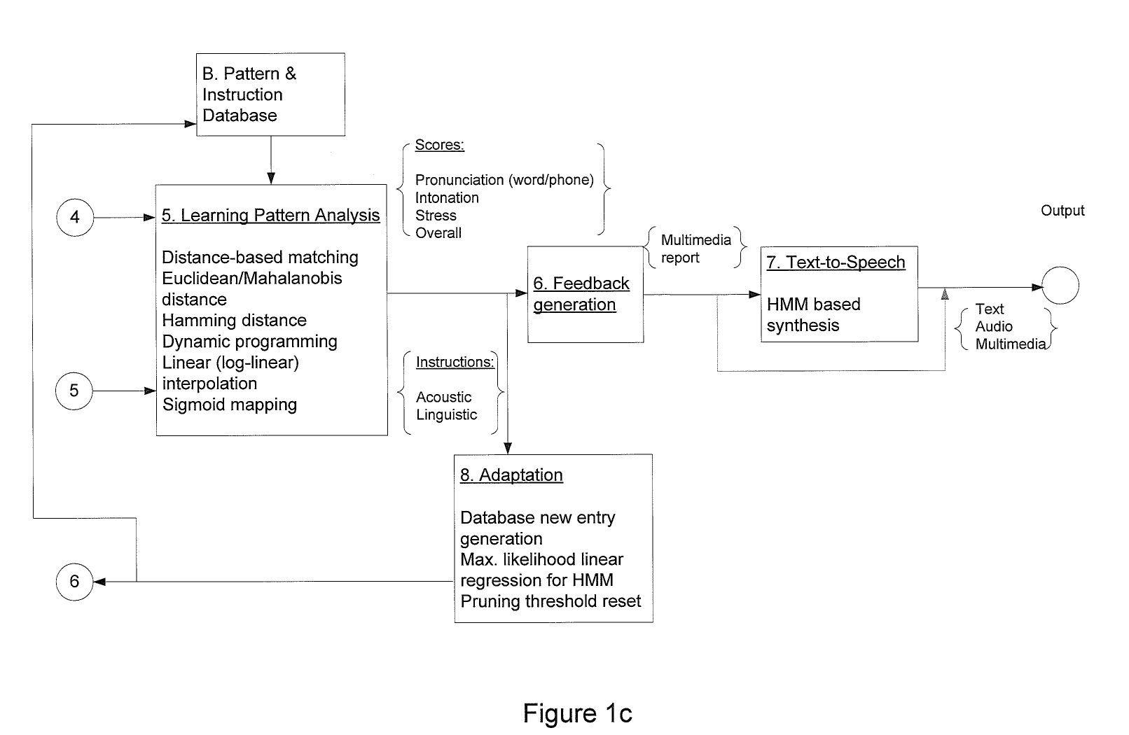

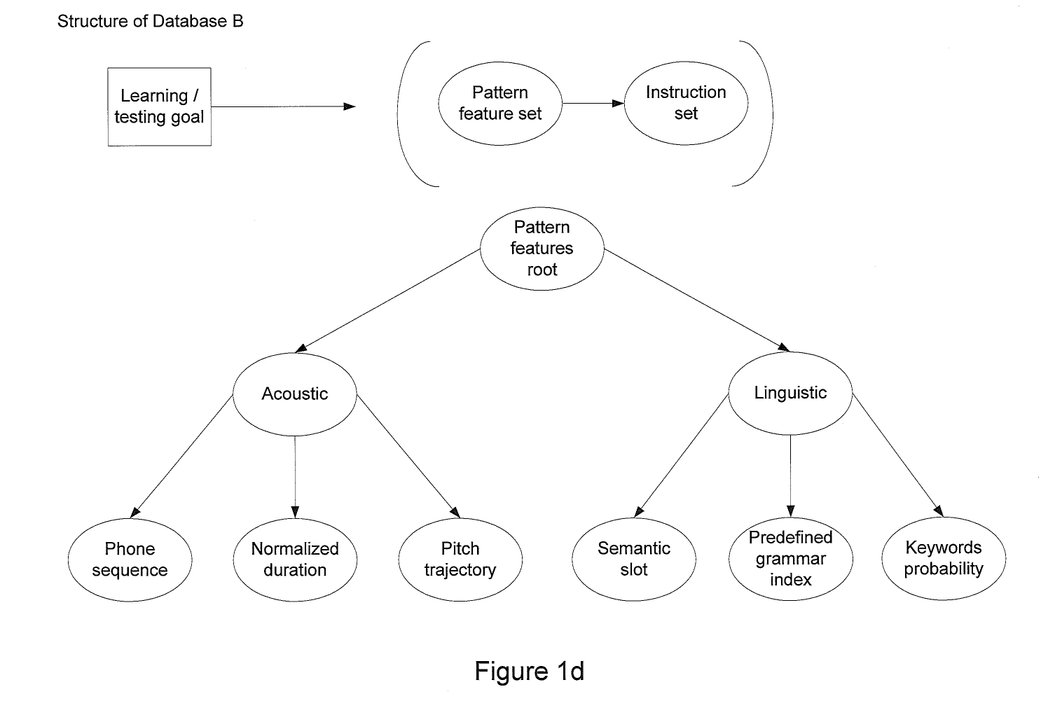

The computer will first prompt an intention in Chinese (e.g. “you want an expensive restaurant” in Chinese) and ask the user to express the intention in English in one sentence. The user will then speak one English sentence to the computer. The computer will then analyze various acoustic and linguistic aspects and/or give a rich evaluation report and improvement instructions. Therefore, the core of the system is the analysis and feedback, which is described step by step as below according to FIG. 1.
Front-end processing (raw feature extraction) in module 1. The user input to the computer is first converted to digitalized audio waveform in the format of Microsoft WAV. The waveform is split into a serial of overlapped segments. The sliding distance between neighboring segments is 10 ms and the size of each segment is 25 ms. Raw acoustic features are then extracted for each segment, i.e., one feature vector per 10 ms. To extract the features, short-time Fourier transform is first performed to get the spectrum of the signals. Then, Perceptual Linear Prediction (PLP) feature, energy and the fundamental frequency, also referred to as pitch value or f0, are extracted. Gaussian window moving average smoothing is applied to the raw pitch value to reduce the problem of pitch doubling during signal processing. For PLP feature extraction, refer to [H. Hermansky, N. Morgan, A. Bayya, and P. Kohn. RASTA-PLP speech analysis technique. In Proc. ICASSP, 1992.], for pitch value extraction, refer to [A. Cheveigh and H. Kawahara. Yin, a fundamental frequency estimator for speech and music. Journal of the Acoustical Society of America, 111 (4), 2002], the energy is the summation of the square of all signals in the segment.
The PLP and energy features are input to a statistical speech recognition module to find
1. the most likely word sequence and phone sequence
2. N alternative word/phone sequences in the form of lattices
3. Acoustic likelihood and language model score of each word/phone arcs
4. time boundary of each word and phone

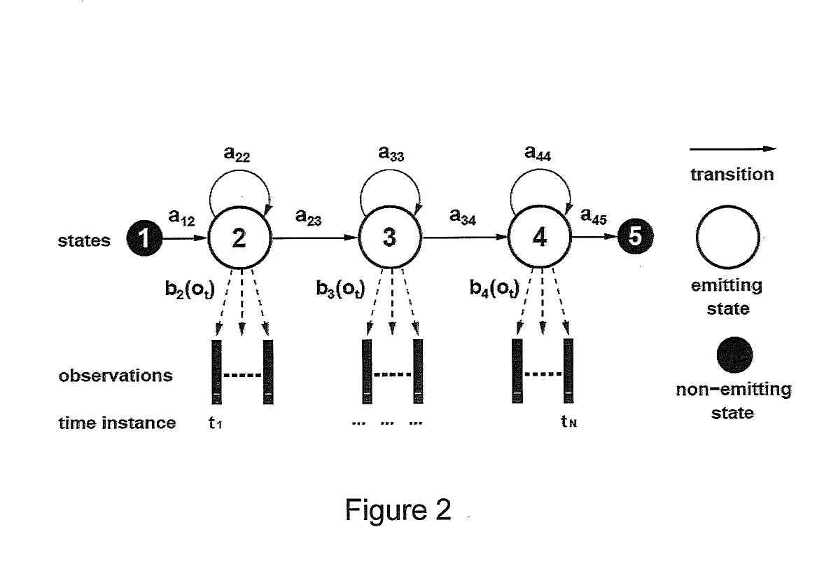

The statistical speech recognition system includes an acoustic model, a language model and a lexicon. The lexicon is a dictionary mapping from words to phones. A multiple-pronunciation lexicon accommodating all non-native pronunciation variations is used here. The language model used here is a tri-gram model, which gives the prior probability of each word, word pairs and word triples. The acoustic model used here is a continuous density Hidden Markov Model (HMM), which is used to model the probability of features (observations) given a particular phone. Left-to-right HMMs are used here, as shown in FIG. 2.

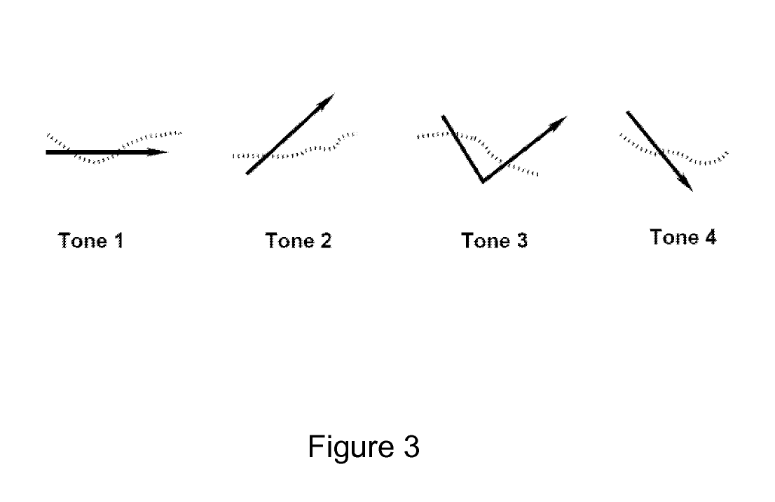

The HMMs used here are state-clustered cross-word triphones. The state output probability is a Gaussian mixture model of the PLP feature vectors including static, first and second derivatives. The search algorithm is Viterbi-like token passing algorithm. The alternative word/phone sequences can be found by retaining multiple tokens during the search. The speech recognition output is represented in HTK lattices, whose technical details can be found in [S. J. Young, D. Kershaw, J. J. Odell, D. Ollaason, V. Valtchev, and P. C. Woodland. (for HTK version 3.0). Cambridge University Engineering Department, 2000]. With a Viterbi algorithm, the time boundary of each words/phones can also be identified. This is useful for subsequent analysis as shown in FIG. 3:

In some learning tasks where the text is given, e.g. intimation, the recognition module may be simplified. This means the pruning threshold during recognition can be enlarged and the recognisor runs much faster. In this case, only the time information and a small number of hypotheses need to be generated.
After speech recognition, acoustic and linguistic analysis are performed. In module 3, the below learning-specific acoustic pattern features are collected or extracted.
   1. Word/phone duration
   2. Word/phone energy
   3. Word/phone pitch value and trajectory
   4. Word/phone confidence scores
   5. Phone hypothesis sequence

Word phone durations are output from module 2. Word energy is calculated as the average energy of the frames within the word

$${E}_{w} = \frac{1}{T} {\sum }_{t = 1}^{T} {E}_{t} \qquad ( 1 )$$

where E_{w} is the word energy and Eₜ is the energy for each frame from module 1. A similar algorithm can be used for calculating phone energy and word/phone pitch values. The pitch trajectory refers to a vector of pitch values corresponding to a word/phone. It is normalised to a standard length using dynamic time warping algorithm. Word confidence score is calculated based on the lattices output from the recognisor. Given the acoustic likelihood and language scores of the word/phone arcs, forward-backward algorithm is used to calculate the posteriors of each arc. The lattices are then converted to a confusion network, where word/phone with similar time boundary and the same content are merged. The posterior of each word/phone are then updated and used as the confidence scores. The detail of the calculation can be found in [G. Evermann and P. C. Woodland. Posterior probability decoding confidence estimation and system combination. In Proc. of the NIST Speech Transcription Workshop 2000]. Phone hypothesis sequence is the most likely phone sequence corresponding to the word sequence from the recognisor.

Module 4 extracts the linguistic pattern features of the user input. They include

1. 1-Best Word sequence

2. Vocabulary of the user

3. Probability of grammatical key words

4. Predefined grammar index

5. Semantic interpretation of the utterance

1-Best word sequence is the output of module 2. Vocabulary refers to the distinct words in the user's input.

A list of grammatical key words are defined in advance. They can be identified using a Hash lookup table. The confidence score of the uttered key words are used as the probability.

A list of grammar is used to parse the word sequence. The parsing is a done by first tagging each word as noun, verb etc. and then checking whether the grammar structure fits in with any of the pre-defined structures, such as “please take [noun/phrases] to [noun/phrases]”. The pre-defined structures are not necessarily just the correct grammar. In addition, a number of common error grammar and alternative grammar to achieve the same user goal are also included. In case of matching, the index is returned. The parsing algorithm is similar to the semantic parsing, except that the grammar structure/terms are used instead of common semantic items.

Robust semantic parsing is also used to get an understanding of the user's input. Here, phrase template based method is used. The detailed algorithm can be found in [S. Seneff. Robust parsing for spoken language systems. In Proc. ICASSP, 2000]. The output of the semantic decoding is the interpretation in the form as:

“request(type=bar,food=Chinese,drink=beer)”.

Having generated learning-specific acoustic and linguistic patterns, analysis is done by matching the pattern to the entries in the predefined pattern and instruction database. The construction of the database is described first as it is the essential for intelligent feedback.

The database includes a number of pattern-instruction pairs given a specific language learning goal as shown in the figure. In the acoustic pattern set, the following duration patterns are used:
1. word/phone duration mean and variance of ideal speech (native speakers and good Chinese speakers)
2. word/phone duration mean and variance of Chinese speakers with 5 proficiency levels (from ok to poor).

Similar patterns exist for word/phone energy and pitch values.

For pitch trajectory, the normalized pitch trajectory for each phone and word are saved in the database. The duration of the normalized pitch trajectory is the mean of the duration of each word/phone, referred to as the normalized duration. The pitch trajectories of all training data are stretched to the normalized duration using dynamic time warping method. For each individual pitch trajectory, the averaged pitch value is subtracted so that the baseline is always normalized to zero. Then, at each normalized time instance, the average pitch value of the training speakers is used as the normalized value. Note that, there are three normalized pitch trajectories corresponding to good/ok/poor.

For confidence scores, the average values of good/ok/poor speakers are all saved.

There are multiple phone to word mappings saved in the database corresponding to the correct phone implementation of the word and different types of wrong implementation. For example, two phone implementation for the word “thank” is saved, one is the correct, another is the implementation corresponding to “sank”.

For linguistic patterns, highly possible words, word sequences for the specific goal are saved as distinct entries in the database. Vocabulary, grammar keywords, semantic interpretations required for the specific goal are also saved. Two separate lists of vocabulary and grammar keywords corresponding to common learning errors are also saved.

In summary, the learning-specific acoustic and linguistic patterns in the database are trained on pre-collected data so that they statistically represent multiple possible patterns (either alternative or specific errors). Each alternative pattern or error pattern has an associated instruction entry in the database given the language learning specific goal. The instructions are collected from human teachers and have both text and multimedia forms. For example, a text instruction of how to discriminate “thank” from “sank” with an audio demonstration.
Module 5 takes the patterns from acoustic and linguistic analysis (module 3 and 4) and matches them to the entries in the database. The output of module 5 are objective scores and improvement instructions, which are calculated/selected based on the matching process.
Distance between the pattern features of module 3/4 and the database are defined as below:
1. Word/phone duration matching employs the Mahalanobis distance between the user duration and reference duration:

$${Δ}_{d} = \frac{{( d - {μ}_{d} )}^{2}}{{σ}_{d}} \qquad ( 2 )$$

where Δ_{d} is the distance between the user duration d and the reference duration pattern in the database. μ_{d} is the mean value of the particular phone or word at a particular proficiency level. σ_{d} is the variance.
2. Word/phone energy Δₑ and pitch Δₚ matching are similar to equation (2).
3. Pitch trajectory matching is done by first normalizing the user's trajectory and then computing the average distance to the reference trajectories in the database.

$${Δ}_{trj} = \frac{1}{T} {\sum }_{t = 1}^{T} {( f ( t ) - {μ}_{f} ( t ) )}^{2} \qquad ( 3 )$$

where Δₜᵣⱼ is the trajectory distance, T is the length of normalized duration, f (t) is the normalized user's pitch value, μ_{f} (t) is the reference normalized pitch value from the database.
4. For distance between symbolic sequences (phones or words or semantic items), the user's input sequence is first aligned to the reference sequence in the database. Then the distance is calculated as the summation of substitution, deletion and insertion errors. The alignment is done using dynamic programming.
Having calculated the above distances given the correct acoustic patterns in the database, general objective scores for the user's pronunciation can be calculated at phone, word or sentence level. Phone level scores are defined as:

$$\begin{matrix}{Δ}_{phn} = - \frac{1}{2} log ( {w}_{1} {Δ}_{d} + {w}_{2} {Δ}_{e} + {w}_{3} {Δ}_{p} ) & ( 4 ) \\ {S}_{phn} = \frac{{w}_{4}}{1 + exp ( {αΔ}_{phn} + β )} + {w}_{5} {C}_{phn} & ( 5 )\end{matrix}$$

where w₁+w₂+w₃=1, w₄+w₅=1 and they are all positive, for example, 0.1, 0.5 etc. Cₚₕₙ is the confidence score of the phone, α and β are parameters of the scoring function. Word level scores Δ_{wrd} are defined similarly. Sentence level scores are defined as the average of word level scores, i.e.

$${S}_{sent} = \frac{1}{{N}_{wrd}} {\sum }_{wrd}^{ } {S}_{wrd} \qquad ( 6 )$$

where N_{wrd} is the number of words in the sentence. Note that, the parameters α and β and the weighting factors in phone and word score calculation are trained in advance so that the artificial output scores have a high correlation coefficient with the expected human teachers' scores.
The linguistic scores are calculated based on the error rate of words and semantic items. Given the distance (number of errors) for word sequence Θ_{wrd} and Θₛₑₘ, the linguistic score is calculated by

$${S}_{ling} = 1 - ( {w}_{1} \frac{{Θ}_{wrd}}{{N}_{wrd}} + {w}_{2} \frac{{Θ}_{sem}}{{N}_{sem}} ) \qquad ( 7 )$$

where w₁+w₂=1 and they are positive, such as 0.1 or 0.2, N_{wrd} is the number of words of the correct word sequence from the database, Nₛₑₘ is the number of semantic items.
In addition to the objective scores, instructions for correcting errors and/or improving speaking skills are also generated. This is done by finding the particular error or speaking patterns in the database. For the acoustic aspects, below personalized instructions are generated:
   1. Mispronounced phones. Using the distance between user's input phone sequence of each word and the sequences in the database, the closest phone sequence in the database is found. If this phone sequence is a typical error, the corresponding instruction is selected.
   2. Intonation analysis. Pitch trajectory indicates the intonation information of words and phones. Given the distance of pitch trajectory, typical wrong intonation are found and corresponding instructions are provided.
   For the linguistic aspects, below personalized instructions are generated:
1. Vocabulary usage instruction. Vocabulary of the user is counted (after the user speak multiple sentences on the same topic). For the words with low counts of the user but high probability in the database, instructions are generated to encourage the user to use the expected words.
2. Grammar correction. If the matched grammar index corresponds to a predefined erroneous grammar, corresponding instructions are provided. If the matched grammar index corresponds to a correct grammar, instructions of other alternative grammar are provided.
3. Grammatical keywords instruction. The ideal grammatical keywords of the specific goal is known in advance. Hence, given the probability of the grammatical keywords uttered by the user, instructions corresponding to the missing or low probability keywords are provided.
4. Semantic instruction. If the matched semantic sequence is not the correct one, the corresponding instructions on why the understanding of the input word sequence is wrong is given.
Module 5 gives different scores and instructions. Module 6 assembles them together to output a detailed scoring report and complete instructions.

The scores for word and phones are presented as histograms and the general scores are presented as a pie chart. The intonation comparison graph is also given, where both the correct pitch curve and the user's pitch curve is given (this is only for those problematic words). Instructions are structured as sections of “Vocabulary usage”, “Grammar evaluation” and “Intelligibility”. In those instructions, some common instruction structures, such as “Alternatively, you can use . . . to express the same idea.”, are used to connect the provided instruction points from the database.
Module 7 converts the text instruction to speech. An HMM based speech synthesisor is used here. This module is omitted for some instructions where there is long texts or multimedia instructions.
During the matching process, in case there is no matching entries in the instruction database, a general instruction requiring further improvement will be given, such as “Your phone realization is far from the correct one. Please change your learning level.”. At the same time, the particular patterns as well as the original audio are saved. At the end of the programme, the saved data are transmitted to a server via internet. Those new patterns are then counted and grouped if the counts reach certain level. Once there is a new group, the data is analyzed by human teacher and an update of the instruction database, e.g. a new type of learning error, is provided on the server. This may then be re-used by all users. On the other hand, once a user makes progress, the system may optionally ask the user to input the know-how, which would be again fed into the system and be included in the database. This adaptation module will keep a dynamic database in terms of both the richness and personalization of the content.

In addition to the content adaptation, the recorded user's audio is also used to update the Hidden Markov Model (HMM) used in speech recognition. Here, Maximum Likelihood Linear Regression (MLLR) [C. J. Leggetter and P. C. Woodland. Speaker adaptation of continuous density HMMs using multivariate linear regression. ICSLP, pages 451-454, 1994] is used to update the mean and variance of the Gaussian Mixture Models in each HMM. The updated model will recognize the user's particular speech better.

Furthermore, statistics of user patterns (especially error patterns) are calculated and saved in the database. Those statistics are mainly the counts of the user's pattern features and corresponding analyzed records indices. Next time, when the same user starts learning, the user can either retrieve his learning history or identify his progress by comparing the current analysis result to the history statistics in the database. The statistics are also used to design personalized learning material, such as personalized practice course or further reading materials, and the like. The statistics can be presented in either numerical or graphical form.

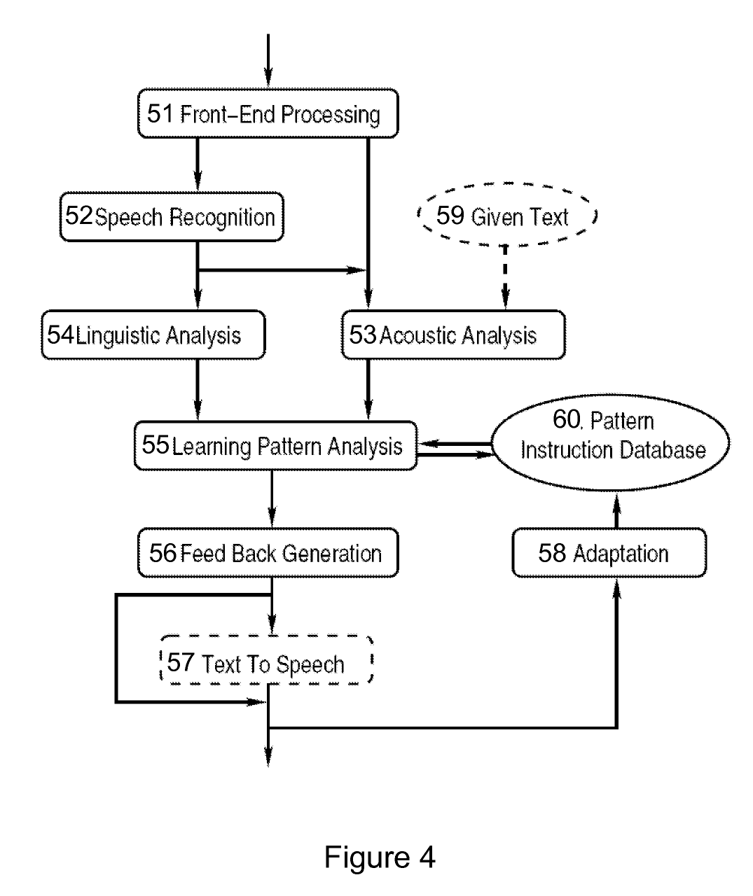

The system is implemented for other languages in a similar way. One additional feature for tonal languages, such as Chinese, is that the instruction on learning tones can be based on a pitch alignment comparison graph as shown in FIG. 4.

In FIG. 4, reference pitch values are given as solid line, which demonstrate the trajectory of the fundamental frequency of the corresponding phone or word. In contrast, the pitch value trajectory produced by the learner are also plotted as dotted-line and aligned to the reference one. This gives the learner an intuitive and meaningful indication of how well the tone is pronounced. This is of great help to improve the learner's tone producing as they can see and correct the process of how tone is produced. The form of the lines, either shape, color or other attributes may vary.

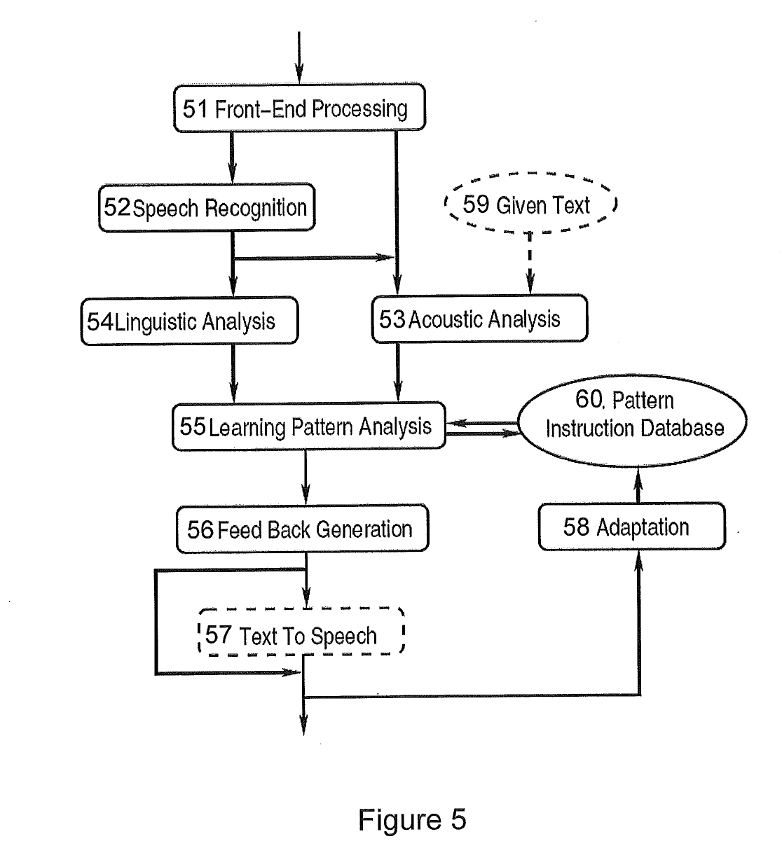

Referring now to FIG. 5, this shows an overview of the above-described systems:
51 shows a front-end processing module. This module performs signal analysis of the input audio. A serial of raw feature vectors are extracted for further speech recognition and analysis. These feature vectors are real value vectors. They may include, but are not limited to, the below kinds:
   Mel-frequency Cepstral coefficient (MFCC)
   Perceptual Linear Prediction (PLP) coefficients
   Energy of the waveform
   Pitch of the waveform
52 shows a speech recognition module. It aims to generate hypothesized word sequence for the input audio, the time boundary of each word and optionally the confidence score of each word. This process is performed based on all or part of the raw acoustic features from module 51. The recognition approach may be, but not limited to:
   Template matching approaches where canonical audio template for each possible word is used to match the input features. The one with the highest matching criterion value is selected as output.
   Probabilistic models based approaches. Probabilistic models, such as hidden Markov model (HMM), are used to model the likelihood of the raw feature vectors given specific word sequence. and/or the prior distribution of the word sequence. The word sequence that maximize the posterior likelihood of the raw acoustic features is selected as output. During the recognition, either grammar based word network or statistical language model may be used to reduce the search space.

The time boundary of each word is automatically output from the recognition process. The confidence score calculation may be performed, but not limited to, as below:
Word posterior of confusion network. Multiple hypotheses may be out-put from the recognizer. The posterior of each word in the hypotheses may then be calculated, which shows the likelihood of the word given all possible hypotheses. This posterior may then be used directly or after appropriate scaling as confidence score of the corresponding word.
Background model likelihood comparison. A background trained on large amount of mixed speech data may be used to calculate the likelihood of the raw feature vectors given each recognized words. This likelihood is then compared to the likelihood calculated based on the specific statistical model for that word. The comparison result, such as a ratio, is used as the confidence score.

This module may be omitted where the text corresponding to the user's input audio is given as shown in 59. of FIG. 5. This is normally for learning of the pure acoustic aspect.
53 shows an acoustic pattern feature extraction module. Taking the output information from module 52 and module 51, this module generates learning specific acoustic pattern features. These pattern features are quantitative and directly reflect the acoustic aspect of speech, such as pronunciation, tone, fluency etc. They may include, but are not limited to:
   Raw audio signal (waveform) of each word
   Raw acoustic features of each word from module 51
   Duration of each spoken word and/or each phones (smallest acoustic unit)
   Average energy of each spoken word
   Pitch values of each word and/or the sentence
   Confidence scores of each word or phone or sentence
54 shows a linguistic pattern feature extraction module. This module takes the output from module 52 and generate a set of learning specific linguistic pattern features. They may include, but are not limited to:
   Word sequence of the user input
   Vocabulary used of the user
   Probability of grammatical key words
   Predefined Grammar index
   Semantic items of the input word sequence
      Grammar index may be obtained by matching the word sequence to a set of predefined finite-state grammar structures. The index of the most likely grammar is then returned. The semantic items may be extracted using a semantic decoder, where a set of word sequence is mapped certain formalized semantic items.
55 shows a learning pattern analysis module. Taking the acoustic and linguistic pattern features from module 53 and 54, these patterns are matched against the patterns in the learning pattern and instruction database 60. The matching process is performed by finding the generalized distance between the input pattern and reference pattern in the database. The distance may be calculated, but not limited to, as below:
   For real-value quantitative pattern features, normalization is performed so that the dynamic range of the value is between 0 and 1. Then, Euclidean distance is calculated.
   An alternative to Euclidean distance is to use a probabilistic model to calculate the likelihood. The likelihood is then used as the distance.
   For index value, if the same index exists in the database, 1 is returned, otherwise 0 is returned.
   For symbols, such as word sequence, Hamming distance is used to calculate the distance.

After the search, a number of instruction records are extracted from the database corresponding to different patterns. The returned records can either be the best record with minimum distance or a set of alternative records selected according to the ranking of the distance. The instructions may include error correction instructions or alternative learning suggestions. The form of the instructions may be text, audio or other multi-media samples. In particular, for tonal languages, such as Chinese, the instruction on learning tones can be in the form of pitch value alignment graph as described above.

In addition to the instructions, real value quantitative scores can be calculated based on the output of module 53 and 54. The scores may include quantitative values for each learning aspect and a general score, for overall performance. They are generally calculated as a non-linear or linear function of the distances between the input pattern features and the reference template features in the database. They may include, but are not limited to, the below:
Pronunciation scores for sentence, word or phone, which may be calculated based on confidence score, duration and energy level.
Tone scores for word or phone, which may be calculated based on pitch values.
Fluency scores, which may be calculated based on confidence scores and pitch values.
Pass rate, which may be calculated as the proportion of the words with high pronunciation/tone/fluency scores
Proficiency, which may be calculated as a weighted linear combination of the above scores.

Once the above raw scores are generated, additional mapping, either linear or non-linear, may be used to normalize the scores to the ones that human teacher may give. This mapping function is statistically trained from large amount of language learning sample data, where both human scores and computer scores are present. The above scores can be presented in either numerical form or graphical form. Contrast table, bar chart, pie chart, histogram, etc. can all be used here.

Therefore, the output of module 55 includes the above instruction records and quantitative scores.
56 shows a feed back generation module. In this module, the instruction records from module 55 and quantitative scores are assembled to give an organized, smooth and general instruction. This final instruction may consist text-based guidance and multi-media samples. This instruction can have a general guidance with the guidance breakdown of different acoustic and/or linguistic aspects. In addition, the quantitative scores from module 55 may be represented as histograms or other form of graphs to visualize the performance result.
57 shows an optional text-to-speech module. Text-based guidance from module 56 may be converted to audio using speech synthesis or pre-recorded human voice.
58 shows an adaptation module of the pattern and instruction database. First, the module adapt the possible feedback information to the need of current learner by using the learning patterns and the analyzed results. Statistics of user patterns (especially error patterns) are calculated and saved in the database. Those statistics are mainly the counts of the user's pattern features and corresponding analyzed records indices. Next time, when the same user starts learning, the user can either retrieve his learning history or identify his progress by comparing the current analysis result to the history statistics in the database. The statistics can also be used to design personalized learning material, such as personalized practice course or further reading materials, etc. The statistics can be presented in either numerical or graphical form.
Second, the adaptation module adapts the database itself to accommodate new knowledge. When new pattern features are found, they would be fed back to a centralized database via network, for example a server via Internet. Those new patterns are then counted and grouped if the counts reach certain level. Once there is a new group, the database is updated to accommodate this new knowledge, for example, a new type of learning error. This may then be re-used by all users. On the other hand, once a user makes progress, the system may optionally ask the user to input the know-how, which would be again fed into the system and be included in the database. This adaptation module will keep a dynamic database in terms of both the richness and personalization of the content.
60 shows the predefined learning pattern and instruction database. Each entry in the database has two main parts: the learning pattern features and corresponding instruction notes. The learning pattern features include acoustic and linguistic features described above in the form of real-valued vectors, symbols or indices. The instruction notes are the answers associated to specific pattern groups. The form can be text, image, audio or video samples or other forms that can make the machine interact with the user. To construct the database, sufficient audio data, corresponding transcriptions, human teacher scores, human teacher instructions need to be collected. The pattern features are then extracted from the training data and grouped for each distinct instruction. When used in module 5, the input pattern features are classified first during the matching process and the instruction of the classified group is output.

Cepstral features reflect the spectrum of the physical realization of the phones and may be used to distinguish between different phones. They are a feature used to find phone/word sequences in the user's speech. Perceptual Linear Prediction (PLP) features are a particular kind of cepstral feature used in speech recognition.

Prosodic features are related to fluency and intonation effect and may be used to evaluate the quality (not the correctness) of the user's pronunciation. Energy and fundamental frequency are prosodic features. In a tonal language like Chinese, fundamental frequency plays an additional role as it may also convey meaning. Therefore fundamental frequency together with cepstral features are preferably used for speech recognition.

Semantic features may be found using a semantic parser on the text output from the speech recognition module. Pre-defined semantic feature templates (both correct and incorrect) are preferably used to match those features and represent the meaning of the pattern.

The first stage of speech recognition is to compress the speech signals into streams of acoustic feature vectors, referred to as observations. The extracted observation vectors are assumed to contain sufficient information and be compact enough for efficient recognition. This process is known as front-end processing or feature extraction. Given the observation sequence, generally three main sources of information are required to recognise, or infer, the most likely word sequence: the lexicon, language model and acoustic model. The lexicon, sometimes referred to as the dictionary, is preferably used in a large vocabulary continuous speech recognition system (LVCSR) to map sub-word units from which the acoustic models are constructed to the actual words present in the vocabulary and language model.

In preferred embodiments the lexicon, acoustic model and language model are not individual modules to process the data, they are the resources required in the speech recognition system. The lexicon is a mapping file from word to sub-word units (e.g. phones). The acoustic model may be a file saving the parameters of a statistical model that gives the likelihood of the front-end features given each individual sub word unit. The acoustic model gives the conditional probability of the features, i.e. the probability of the cepstral features of some speech given a fixed word/phone sequence. The language model may be another file saving the prior probability of each possible word sequence, providing the prior probability of possible word or phone sequences.

The language model represents the local syntactic and semantic information of the uttered sentences. It contains information about the possibility of each word sequence. The acoustic model maps the acoustic observations to the sub-word units. Statistical approaches are preferred recognition algorithms to hypothesise the word sequence.

The lexicon/language model/acoustic model structure may be implemented in many ways, by analogy with the structure of a LVCSR. The “language model” may be a finite state grammar or a statistical n-gram model. The finite state grammar model is preferred for small and limited-domain speech recognition task, while the statistical n-gram model is preferred for natural speech recognition. Preferably a statistical n-gram model is used in the speech recognition system, which makes the module more powerful and robust to random noise. The acoustic model may be combined with language model probability for the final recognition.

Acoustic patterns preferably comprise features extracted for identifying pronunciation quality. They are high-level (or 2nd level) features that may be directly related to pronunciation evaluation. By using confusing phone hypotheses, the nativeness of the user may be detected and specific phone errors may be identified.

Predefined error patterns are preferably produced and used for both acoustic and linguistic patterns. The predefined error patterns may be statistically estimated and saved in the pattern and instruction database. The linguistic error patterns may comprise predefined error linguistic structures (such as grammar structure), and the acoustic error patterns may be wrong pitch trajectories or confusing phone sequences (such as the phone sequence produced by certain non-native speakers). The error patterns are preferably generated by running the speech recognition and pattern extraction modules on pre-collected audio data with errors. When the system is being used, the error patterns may then be used by the pattern matching module 5 in FIG. 1.

No doubt many other effective alternatives will occur to the skilled person. It will be understood that the invention is not limited to the described embodiments and encompasses modifications apparent to those skilled in the art lying within the spirit and scope of the claims appended hereto.

I claim:

1. A computing system to facilitate learning of a spoken language, the system comprising:
a user interface to prompt a user of the system to produce a spoken language goal and to capture audio data comprising speech captured from said user in response;
a speech analysis system to analyse said captured audio data to determine acoustic or linguistic pattern features of said captured audio data;
a pattern matching system to match one or more subsets of said pattern features to a database of pattern features and to determine feedback data responsive to said match; and
a feedback system to provide feedback to said user using said feedback data to facilitate said user to achieve said spoken language goal.

2. A computing system as claimed in claim 1 wherein said database of pattern features is configured to store sets of linked data items, a said set of linked data items comprising a feature data item comprising a group of said pattern features for identifying an expected spoken response from said user to said spoken language goal, an instruction data item, said instruction data item comprising instruction data for instructing said user to improve or correct an error in said captured speech identified by said match, and a goal data item identifying said spoken language goal, such that said spoken language goal identifies a said set of said linked data items comprising a set of expected responses to said spoken language goal and a corresponding set of instruction data items for instructing said user to improve or correct an error in said captured speech, and wherein said pattern matching system is configured to match said pattern features of said captured audio data to pattern features of a said feature data item in a said set corresponding to said spoken language goal, and wherein said feedback comprises instructions to said user derived from said instruction data from a said instruction data item linked to said matched feature data item, whereby said instructions to said user correspond to an identified response from a set of expected responses to said spoken language goal.

3. A computing system as claimed in claim 1 wherein said speech analysis system comprises an acoustic pattern analysis system to identify one or more of phones, words and sentences from said spoken language in said captured audio data and to provide associated confidence data, and wherein said acoustic pattern features comprise one or more of phones, words and sentences and associated confidence scores, and
wherein said acoustic pattern analysis system is further configured to identify prosodic features in said captured audio data, a said prosodic feature comprising a combination of a determined fundamental frequency of a segment of said captured audio corresponding to a said phone or word, a duration of said segment of captured audio, and an energy in said segment of captured audio, and wherein said acoustic pattern features include said prosodic features.

4. A computing system as claimed in claim 3 wherein said speech analysis system includes a linguistic pattern analysis system to match a grammar employed by said user to one or more of a plurality of types of grammatical structure, and wherein said linguistic pattern features comprise grammatical pattern features of said captured speech, and
wherein one or both of said plurality of types of grammatical structure and said identified phones, words or sentences include erroneous types of grammatical structure or phones, words or sentences.

5. A computing system as claimed in claim 3 wherein said linguistic pattern analysis system is configured to identify key words of a set of key words, and wherein said acoustic pattern analysis system is configured to provide confidence data for said identified key words, wherein said pattern features include confidence scores for said identified key words.

6. A computing system as claimed in claim 1 wherein said speech analysis system comprises a speech recognition system including both an acoustic model to provide said acoustic pattern features and a linguistic model to provide said linguistic pattern features.

7. A computing system as claimed in claim 6 wherein said speech recognition system is configured to provide data identifying one or both of phone and word boundaries, and wherein said pattern features include features of said portions of said captured audio data segmented at said phone or word boundaries.

8. A computing system as claimed in claim 1 wherein said feedback data comprises an index to index a selected instruction record of a set of instruction records responsive to a combination of a said match and said goal, said instruction recording comprising instruction data for instructing said user to improve or correct an error in said captured speech identified by said match, and wherein said feedback comprises instructions to said user derived from said instruction data to improve or correct said user's speech.

9. A computing system as claimed in claim 1 wherein said feedback data is hierarchically arranged having a hierarchy including at least an acoustic level and a linguistic level, and wherein said feedback system is configured to select a level in said hierarchy responsive to one or both of said spoken language goal and a level of determined skilled in said spoken language of said user, and
wherein said feedback to said user includes a score, wherein said score is determined by modifying a value derived from a goodness of said match by a mapping function, and wherein said mapping function is determined such that scores from said computer system correlate with corresponding scores by humans.

10. A computing system as claimed in claim 1 wherein said spoken language comprises a tonal language, and wherein said feedback data comprises pitch trajectory data, and
wherein said feedback to said user comprises a graphical representation of said user's pitch trajectory for a phone, word or sentence of said tonal language and a graphical indication of a corresponding desired pitch trajectory.

11. A computing system as claimed in claim 1 further comprising a historical data store to store historical data from a plurality of different users comprising one or both of said determined acoustic pattern features and said determined linguistic pattern features, and a system to identify within said historical data new pattern features not within said database of pattern features and to add said new pattern features to said database of pattern features responsive to said identification, and
further comprising a system to add new feedback data to said database corresponding to said new pattern features, and wherein said new feedback data comprises data captured from one or more users by questioning a said user as to how an error in said captured speech associated with a new pattern feature was overcome.

12. A computer system as claimed in claim 1 to facilitate testing of a said spoken language in addition to or instead of facilitating learning of said spoken language, wherein said feedback system is configured to produce a test result in addition to or instead of providing feedback to said user.

13. A carrier carrying computer program code to, when running, facilitate learning of a spoken language, the code comprising code to implement:
a user interface to prompt a user of the system to produce a spoken language goal and to capture audio data comprising speech captured from said user in response;
a speech analysis system to analyse said captured audio data to determine acoustic or linguistic pattern features of said captured audio data;
a pattern matching system to match one or more subsets of said pattern features to a database of pattern features and to determine feedback data responsive to said match; and
a feedback system to provide feedback to said user using said feedback data to facilitate said user to achieve said spoken language goal.

14. A speech processing system for processing speech and outputting instruction data items responsive to identified acoustic and linguistic patterns in said speech, the system comprising:
a front end processing module, having an input to receive analogue speech data, an analogue to digital converter to convert said analogue speech data into digital speech data, means for performing a Fourier analysis on said digital speech data to provide a frequency spectrum of said digital speech data, means for generating feature vector data and prosodic feature data from said frequency spectrum of said digital speech data, said prosodic feature data comprising a combination of a determined fundamental frequency of a segment of said digital speech data corresponding to a phone or a word, a duration of said digital speech data and an energy in said segment of digital speech data;
a statistical speech recognition module coupled to said front end processing module, having an input to receive said feature vector data and said prosodic feature data, and comprising a lexicon, an acoustic model, and a language model,
said lexicon having an input to receive said prosodic feature data, a memory storing a pre-determined mapping of said prosodic feature data to acoustic data items, and an output to output said acoustic data items, said acoustic data items being one or more of data defining phones and data defining words and data defining syllables,
said acoustic model having an input to receive said acoustic data items, said feature vector data and said prosodic feature data, and comprising a probabilistic model operable to determine the probability of said acoustic data items existing in said feature vector data and said prosodic feature data, selecting said acoustic data items with a highest match probability and outputting said acoustic data items with said highest match probability,
said language model having an input to receive said acoustic data items from said lexicon and an output to output a language data item, said language data item comprising data identifying one or more of phones, words and syllables in said digital speech data, the language model comprising means to analyse at least one previously generated language data item and said acoustic data items from said lexicon and to generate a further said language data item for output;
an acoustic pattern feature extraction module coupled to said statistical speech recognition module and said front end processing module, having an input to receive said acoustic data items from said statistical speech recognition module, having an input to receive said prosodic feature data from said front end processing module, and means for determining acoustic features of said acoustic data items from said prosodic data items, said acoustic features comprising pitch trajectory, and outputting acoustic feature data items defining said acoustic features;
a linguistic pattern feature extraction module coupled to said statistical speech recognition module and having an input to receive said language data items, a memory storing predefined linguistic structures, said linguistic structures storing at least one of grammatical patterns and semantic patterns, means for matching said language data items to said predefined linguistic structures, and means for outputting a linguistic structure data item comprising data characterising a linguistic structure of said language data items according to said predefined linguistic structures in said linguistic structure memory;
a pattern feature memory, configured to store a plurality of pattern-instruction pairs, a pattern item in said pattern-instruction pair defining a language learning goal and an instruction in said pattern-instruction pair defining an instruction item responsive to said pattern item defining a language learning goal;
a pattern matching module coupled to said acoustic pattern feature extraction module and said linguistic pattern feature extraction module and said pattern feature memory, having an input to receive said acoustic feature data items from said acoustic pattern feature extraction module, having an input to receive said linguistic structure data items from said linguistic pattern feature extraction module, and
means for matching said acoustic feature data items to said plurality of pattern-instruction pairs in said pattern feature memory by comparing said pattern items in said pattern-instruction pair and said acoustic feature data items output from said acoustic pattern feature extraction module,
means for matching said linguistic structure data items to said plurality of pattern-instruction pairs by comparing said linguistic structure data items with said pattern items in said plurality of acoustic and linguistic pattern-instruction pairs,
outputting said instruction items responsive to said pattern items in said plurality of acoustic and linguistic pattern-instruction pairs.

15. A speech processing system as claimed in claim 14 wherein said pattern item in said pattern-instruction pair defines an erroneous language learning goal and said instruction in said pattern-instruction pair defines an instruction item responsive to said pattern item, said instruction item comprising data for instructing correction of at least one of said acoustic feature data items and said linguistic structure data items matching said pattern item defining an erroneous language learning goal.

16. A speech processing system as claimed in claim 14 wherein said feature vector data generated in said front end processing module is perceptual linear prediction (PLP) feature data.

17. A speech processing system as claimed in claim 14 wherein said acoustic features determined in said acoustic pattern feature extraction module further comprise at least one of duration and energy and confidence score of said acoustic data items.

18. A speech processing system as claimed in claim 14 wherein said probabilistic model in said acoustic model is a Hidden Markov Model.

19. A speech processing system as claimed in claim 14 further comprising an adaptation module, said adaptation module comprising an historical memory configured to store historical data items from a plurality of different users comprising one or both of said acoustic feature data items and said linguistic structure data items, and means to identify within said historical data items new pattern items not within said pattern feature memory and to add said new pattern items to said pattern-instruction pairs in said pattern feature memory responsive to said identification.

20. A speech processing system as claimed in claim 19 wherein the adaptation module is further operable to add new instruction items to said pattern-instruction pairs in said pattern feature memory, wherein said new instruction items comprise data captured from new digital speech data generated from said users defining a response associated with said new pattern items added to said pattern feature memory.
